(19) United States
(12) Patent Application Publication
(10) Pub. No.: US 2011/0244983 A1
(43) Pub. Date: Oct. 6, 2011

(54) GOLF BALL POLYURETHANE LAYER ADHESION PROMOTER

(75) Inventors: KONG SHEN, CARLSBAD, CA (US); SHANE R. PARNELL, CARLSBAD, CA (US); DAVID M. BARTELS, CARLSBAD, CA (US)

(73) Assignee: CALLAWAY GOLF COMPANY, CARLSBAD, CA (US)

(21) Appl. No.: 13/074,591

(22) Filed: Mar. 29, 2011

Related U.S. Application Data
(60) Provisional application No. 61/318,870, filed on Mar. 30, 2010.

(51) Int. Cl. A63B 37/00; B05D 1/18; B05D 1/02

(52) U.S. Cl. 473/371; 427/372.2

(57) ABSTRACT

The method of the present invention comprises dissolving an aziridine in water in a 1:1 ratio to form an aziridine-water solution. Then, pouring the aziridine-water solution into a water-born polyurethane dispersion while stirring to form a resultant polyurethane dispersion and diluting the resultant polyurethane dispersion with distilled water to form a diluted polyurethane dispersion. The mantle core 22 of the golf ball 20 is then immersed into the diluted polyurethane dispersion to form a coated mantle core and lastly, the coated mantle core 22 is dried at room temperature.

### CROSS REFERENCES TO RELATED APPLICATIONS

This application claims priority to U.S. Provisional Patent Application No. 61/318,870 filed on Mar. 30, 2010.

### STATEMENT REGARDING FEDERALLY SPONSORED RESEARCH OR DEVELOPMENT

Not Applicable

### BACKGROUND OF THE INVENTION

1. Field of the Invention

The present invention relates to the manufacture of golf balls. Particularly to the manufacture of golf balls comprising a surlyn mantle and polyurethane cover.

2. Description of the Related Art

The prior art discloses various methods for manufacturing golf balls utilizing suryln mantle cores and polyurethane covers. However, the prior art fails to provide a method

Polyurethane (PU) balls using reaction injection molding (RIM) technology have poor adhesion between the surlyn mantle and PU cover. The RIM cover is separated from inside the mantle and core during impact because of the poor adhesion between the ionomer mantle and polyurethane cover. No significant improvement has been made despite multiple efforts to improve the adhesion between the ionomer mantle cover and the polyurethane cover.

The use of the technology of water-born polyurethane dispersion, PUD, that contains an aziridine overcomes the problem of poor adhesion between mantle and the polyurethane cover. This technology produces a golf ball polyurethane cover with improved durability, resilience, feel, spin and impact durability.

### BRIEF SUMMARY OF THE INVENTION

The major goal of this invention is to resolve the problem of poor adhesion of reaction injection molded (RIM) covers over the ionomer mantle layers to provide a durable RIM golf ball that has improved resilience, feel, spin and impact durability. The invented technology allows for a polyurethane cover to adhere firmly and strongly to the mantle layer to yield an improved RIM golf ball.

One aspect of the present invention is a method for forming a golf ball, the method comprising dissolving an aziridine in water in a 1:1 ratio to form an aziridine-water solution. Then, pouring the aziridine-water solution into a water-born polyurethane dispersion while stirring to form a resultant polyurethane dispersion and diluting the resultant polyurethane dispersion with distilled water to form a diluted polyurethane dispersion. The mantle core of the golf ball is then immersed into the diluted polyurethane dispersion to form a coated mantle core for a certain time and lastly, the coated mantle core is dried at room temperature.

Another aspect of the present invention is a method for forming a golf ball, the process comprising dissolving an aziridine in water in a 1:1 ratio to form an aziridine-water solution and pouring the aziridine-water solution into a water-born polyurethane dispersion while stirring to form a resultant polyurethane dispersion. The mantle core is then loaded on spindles of a painting line. The resultant polyurethane dispersion is then sprayed on the spinning mantle cores as they are passing through in front of the spraying guns, and then the mantle core is dried at room temperature.

Yet another aspect of the present invention is a golf ball with improved adhesion between the polyurethane cover and ionomer mantle. The golf ball comprises a resultant polyurethane dispersion sprayed over a ionomer mantle and a polyurethane cover formed over the ionomer mantle core using reaction injection molding.

A further aspect of the present invention is a golf ball with improved adhesion between the polyurethane cover and ionomer mantle. The golf ball comprises a ionomer mantle core coated with a diluted polyurethane dispersion and a polyurethane cover formed over the ionomer mantle core using reaction injection molding.

Having briefly described the present invention, the above and further objects, features and advantages thereof will be recognized by those skilled in the pertinent art from the following detailed description of the invention when taken in conjunction with the accompanying drawings.

### BRIEF DESCRIPTION OF THE SEVERAL VIEWS OF THE DRAWINGS

FIG. 1 is a perspective view of the present invention.

FIG. 2 is a cross sectional view of the present invention.

### DETAILED DESCRIPTION OF THE INVENTION

A water-born polyurethane dispersion (PUD) is blended with an aziridine and applied on an ionomer mantle 23 surface by either a dipping or spraying process. PUD coated mantle cores 22 are air-dried at room temperature. A polyurethane layer 24 is molded, injection molded or reaction injection molded (RIM), over PUD-coated air-dried mantle cores 22 to form golf balls 20. The golf balls 20 are then posted cured. The polyurethane cover layer 24 and mantle layer 23 are adhered to each other. The cover layer 24 is evaluated by a standard peeling test. On a scale of 1 (poorest adhesion) to 5 (best adhesion), polyurethane cover 24 adhesion increases to 4-5 from 1-2 on the scale compared to golf balls 20 where no PUD/aziridine is applied on mantle layer 23. Adhesion between polyurethane cover 24 and mantle 23 layer is dramatically improved.

The present invention relates to a method for forming a golf ball 20. The method comprises dissolving an aziridine in water in a 1:1 ratio to form an aziridine-water solution. Then, pouring the aziridine-water solution into a water-born polyurethane dispersion while stirring to form a resultant polyurethane dispersion and diluting the resultant polyurethane dispersion with distilled water to form a diluted polyurethane dispersion. The mantle 23 over the core 22 of the golf ball 20 is then immersed into the diluted polyurethane dispersion to form a coated mantle 23 and lastly, the coated mantle 23 is dried at room temperature.

The method further comprises forming a polyurethane cover 24 over the mantle 23 using reaction injection molding. Preferably, the polyurethane cover 24 has a thickness ranging from 0.01 inch to 0.05 inch. The time between immersing the mantle 23 over the core 22 of a golf ball 20 and forming a polyurethane cover 24 over the mantle 23 is preferably 8 hours. Alternatively, the time between immersing the mantle 23 of a golf ball 20 and forming a polyurethane cover 24 over the mantle 23 is 1.25 hours, 1.5 hours, 2 hours, 24 hours, 48 hours or 72 hours. The temperature at which the polyurethane cover 24 is formed over the mantle 23 is preferably 150 degrees Faranheit. The aziridine is preferably a CX-100. Alternatively, the aziridne is a Xama 7 or Xama 2. The water-born polyurethane dispersion is preferably Witco 238S. In a preferred embodiment of the method of the present invention, the water-born polyurethane dispersion to aziridine to distilled water ratio is 100/5/1600 by mass. Alternatively, the ratio is 100/5/800, 100/5/2400, or 100/5/3200.

Another aspect of the present invention is a method for forming a golf ball 20 wherein the method comprises dissolving an aziridine in water in a 1:1 ratio to form an aziridine-water solution. The aziridine-water solution is poured into a water-born polyurethane dispersion while stirring to form a resultant polyurethane dispersion. The mantle 23 of a golf ball 20 is loaded on spindles of a painting line, preferably a PDS system, and the resultant polyurethane dispersion is sprayed on the mantle 23 as they are passing through in front of the spraying guns. The mantle 23 of the golf ball 20 is then dried at room temperature. The spraying guns are preferably Binks HVLP spraying guns.

The method further comprises forming a polyurethane cover 24 over the mantle 23 using reaction injection molding.

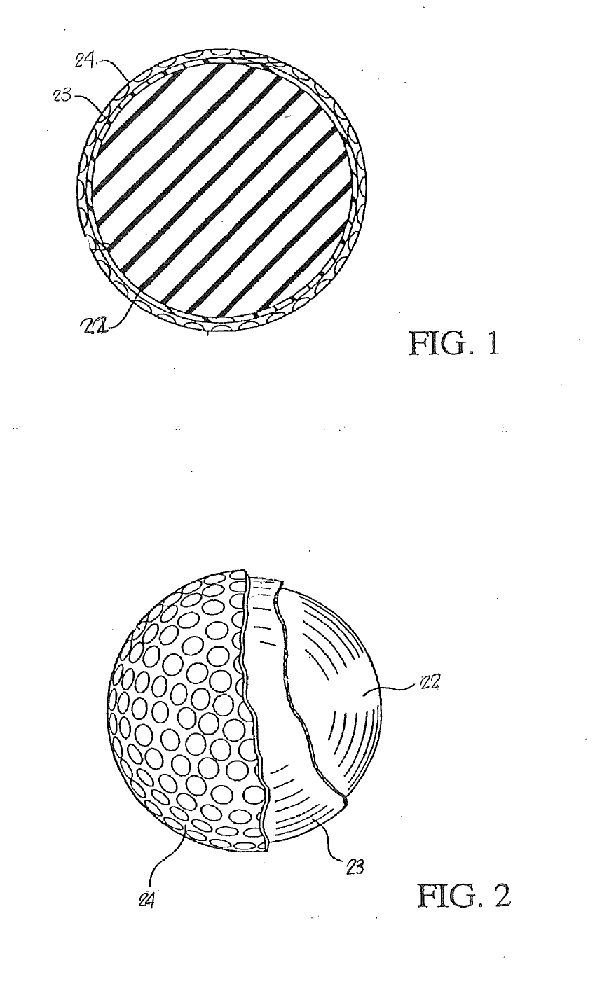

As shown in FIG. 1, another aspect of the present invention is a golf ball 20 with improved adhesion between the polyurethane cover 24 and ionomer mantle 23. The golf ball 20 comprises an ionomer mantle 23 coated with a diluted polyurethane dispersion and a polyurethane cover 24 formed over the ionomer mantle 23 using reaction injection molding.

A further aspect of the present invention is a golf ball 20 with improved adhesion between the polyurethane cover 24 and the ionomer mantle 23. The golf ball 20 comprises an ionomer mantle 23 coated with a diluted polyurethane dispersion and a polyurethane cover 24 formed over the ionomer mantle 23 using reaction injection molding.

CX-100 is a multi-functional aziridine. It has a number of basic functional groups that react with acidic functional groups of surlyn and acidic functional groups in polyurethane dispersion. The aziridine functions as a binder that connects surlyn substrate and polyurethane disperson. The polyurethane dispersion coated mantle core must be air dried as the polyurethane dispersion contains a small amount of water. The water is yet another binder which promoted the binding of the reaction injection molded polyurethane cover and the polyurethane dispersion coated mantle core.

Experimental results showing the improvement of golf ball characteristics using the PUD/aziridine solution are shown in Table 1 and Table 2.

TABLE 1
Mantle Adhesion Promotor

| | Adhesion | | | | | Dwell | | |
|---|---|---|---|---|---|---|---|---|
| Adhesion | Promotor | | | | | Time | | |
| Promotor | Solution | Dip Time | Balls | Dip Solution | Dip Solution Age | between | Postcure | Postcure |
| Solution | Composition | (min) | per Dip | Volume (ml) | (hr) | Dip and | Temp. (° F.) | Time (hr) |
| W235S/CX1 | 100/5/1600 | 3 | 36 | 2000 | <1 | 5 | 150 | 1 hr 45 min |
| W235S/CX1 | 100/5/1600 | 3 | 36 | 2000 | <1 | 24 | 150 | 1 hr 45 min |
| W235S/CX1 | 100/5/1600 | 3 | 36 | 2000 | <1 | 48 | 150 | 1 hr 45 min |
| W235S/CX1 | 100/5/1600 | 3 | 36 | 2000 | <1 | 72 | 150 | 1 hr 45 min |
| W235S/CX1 | 100/5/800 | 3 | 36 | 2000 | <1 | 2 | 150 | 1 hr 45 min |
| W235S/CX1 | 100/5/1600 | 3 | 36 | 2000 | <1 | 2 | 150 | 1 hr 45 min |
| W235S/CX1 | 100/5/2400 | 3 | 36 | 2000 | <1 | 2 | 150 | 1 hr 45 min |
| W235S/CX1 | 100/5/3200 | 3 | 36 | 2000 | <1 | 2 | 150 | 1 hr 45 min |
| W235S/CX1 | 100/5/1600 | 3 | 21 | 1705 | 0.25 | 1.25 | 150 | 1 hr 45 min |
| W235S/CX1 | 100/5/1600 | 3 | 21 | <1705 | 2 | 1.5 | 150 | 1 hr 45 min |
| W235S/CX1 | 100/5/1600 | 3 | 21 | <1705 | 4 | 1.5 | 150 | 1 hr 45 min |
| W235S/CX1 | 100/5/1600 | 3 | 21 | <1705 | 8 | 1.5 | 150 | 1 hr 45 min |
| W235S/CX1 | 100/5/1600 | 3 | 21 | <1705 | 24 | 1.5 | 150 | 1 hr 45 min |

TABLE 2

| Sample Identification | | | | |
|---|---|---|---|---|
| | | | Dwell Time | |
| | | | Between D.I. | Ball Performance |
| | | | Rinse and | Wet Quality Peel Best- |
| Experiment | # Balls | D.I. Rinse | Dip (Hr) | Worst (5-1) |
| 1 | 36 | yes | <2 | 5 |
| 2 | 36 | yes | <2 | 3.8 |
| 3 | 36 | yes | <2 | 3.7 |
| 4 | 36 | yes | <2 | 3.9 |
| 5 | 36 | yes | <2 | 5 |
| 6 | 36 | yes | <2 | 3.8 |
| 7 | 36 | yes | <2 | 4.3 |
| 8 | 36 | yes | <2 | 3.8 |
| 9 | 36 | yes | <2 | 4.5 |
| 10 | 36 | yes | <2 | 3.9 |
| 11 | 36 | yes | <2 | 4.1 |
| 12 | 36 | yes | <2 | 3.7 |
| 13 | 36 | yes | <2 | 3.8 |

Various reaction injection molding methods are disclosed in U.S. Pat. No. 7,244,196 for a Golf Ball Which Includes Fast-Chemical-Reaction-Produced Component and Method of Making Same, U.S. Pat. No. 7,534,384 for Process For Producing a Golf Ball with Deep Dimples, U.S. Pat. No. 7,241,232 for Golf Ball Having Dual Core and Thin Polyurethane Cover Formed by RIM and U.S. Pat. No. 7,338,391 for Golf Ball Which Includes Fast-Chemical-Reaction-Produced Component and Method of Making Same which are all owned by Callaway Golf Company and which pertinent parts are hereby incorporated by reference.

From the foregoing it is believed that those skilled in the pertinent art will recognize the meritorious advancement of this invention and will readily understand that while the present invention has been described in association with a preferred embodiment thereof, and other embodiments illustrated in the accompanying drawings, numerous changes, modifications and substitutions of equivalents may be made therein without departing from the spirit and scope of this invention which is intended to be unlimited by the foregoing except as may appear in the following appended claims. Therefore, the embodiments of the invention in which an exclusive property or privilege is claimed are defined in the following appended claims.

We claim as our invention the following:

1. A method for forming a golf ball, the method comprising:
dissolving an aziridine in water in a 1:1 ratio to form an aziridine-water solution;
pouring the aziridine-water solution into a water-born polyurethane dispersion while stirring to form a resultant polyurethane dispersion;
diluting the resultant polyurethane dispersion with distilled water to form a diluted polyurethane dispersion;
immersing a mantle core of a golf ball into the diluted polyurethane dispersion to form a coated mantle core; and
drying the coated mantle core at room temperature.

2. The method according to claim 1 further comprising forming a polyurethane cover over the mantle core using reaction injection molding.

3. The method according to claim 2 wherein the polyurethane cover has a thickness ranging from 0.01 inch to 0.05 inch.

4. The method according to claim 2 wherein the time between immersing the mantle core of a golf ball and forming a polyurethane cover over the mantle core is 8 hours.

5. The method according to claim 2 wherein time between immersing the mantle core of a golf ball and forming a polyurethane cover over the mantle core is 24 hours.

6. The method according to claim 2 wherein time between immersing the mantle core of a golf ball and forming a polyurethane cover over the mantle core is 48 hours.

7. The method according to claim 2 wherein time between immersing the mantle core of a golf ball and forming a polyurethane cover over the mantle core is 72 hours.

8. The method according to claim 2 wherein the temperature at which the polyurethane cover is formed over the mantle core is 150 degrees Faranheit.

9. The method according to claim 1 wherein the aziridine is a CX-100, Xama 7 or Xama 2.

10. The method according to claim 1 wherein the water-born polyurethane dispersion is Witco 238S.

11. The method according to claim 1 wherein the water-born polyurethane dispersion to aziridine to distilled water ratio is 100/5/1600 by mass.

12. The method according to claim 1 wherein the water-born polyurethane dispersion to aziridine to distilled water ratio is 100/5/800 by mass.

13. The method according to claim 1 wherein the water-born polyurethane dispersion to aziridine to distilled water ratio is 100/5/2400 by mass.

14. A method for forming a golf ball, the process comprising:
dissolving an aziridine in water in a 1:1 ratio to form an aziridine-water solution;
pouring the aziridine-water solution into a water-born polyurethane dispersion while stirring to form a resultant polyurethane dispersion;
loading a mantle core of a golf ball on spindles of a painting line;
spraying the resultant polyurethane dispersion; and
drying the mantle core of the golf ball at room temperature.

15. The method according to claim 14 wherein the aziridine is a CX-100, Xama 7 or Xama 2.

16. The method according to claim 14 wherein the water-born polyurethane dispersion is Witco 238S.

17. The method according to claim 14 wherein the painting line comprises a PDS system.

18. The method according to claim 17 wherein the PDS system comprises Binks HVLP spraying guns, which spray the mantle core.

19. A golf ball with improved adhesion between the polyurethane cover and suryln mantle, the golf ball comprising:
a resultant polyurethane dispersion sprayed over a suryln mantle; and
a polyurethane cover formed over the suryln mantle core using reaction injection molding.

20. A golf ball with improved adhesion between the polyurethane cover and suryln mantle, the golf ball comprising
a suryln mantle core coated with a diluted polyurethane dispersion; and
a polyurethane cover formed over the suryln mantle core using reaction injection molding.
